(19) United States
(12) Patent Application Publication
(10) Pub. No.: US 2019/0188706 A1
(43) Pub. Date: Jun. 20, 2019

(54) TRANSFERENCE TRACKING

(71) Applicant: Apple Inc., Cupertino, CA (US)

(72) Inventor: Brian C. McCurtis, Leander, TX (US)

(21) Appl. No.: 15/891,681

(22) Filed: Feb. 8, 2018

Related U.S. Application Data
(60) Provisional application No. 62/607,061, filed on Dec. 18, 2017.

(51) Int. Cl. G06Q 20/40; G06Q 20/02; H04L 9/32; H04L 9/06; H04L 29/08; G06F 9/455

(52) U.S. Cl. CPC G06Q 20/40; G06Q 20/02; G06F 9/45558; H04L 9/0637; H04L 67/104; H04L 9/3236

(57) ABSTRACT

Systems and methods are disclosed that provide for a blockchain-based transference tracking system to authenticate and register electronic transaction records. The transference tracking system, in one embodiment, is a permissioned, peer-to-peer, decentralized network containing an authorized, verifiable ledger of electronic transaction records that can be shared amongst authenticated actors. The decentralized ledger can be used as a substitute for a centralized database and enables automated tracking and reporting of electronic transaction records to an authoritative, but non-central authority using the blockchain of the transference tracking system.

### CROSS-REFERENCE

This application claims priority to U.S. Provisional Patent Application No. 62/607,061 filed Dec. 18, 2017, which is hereby incorporated herein by reference.

### TECHNICAL FIELD

This disclosure relates generally to the field of cryptographic systems to facilitate secure transfer transactions, and more specifically to a computational system to enable blockchain-based electronic transference tracking based on a customizable rule system.

### BACKGROUND

Multi-national corporations track a number of fiscal and tax law systems for the various regions and legal jurisdictions in which those corporations are active. Governments that conduct business with multi-national corporations may implement transference tracking models that can require near real-time invoice authorization by the government to enable the provision of goods and services. As laws and regulations within those jurisdictions change, corporations may be required to rapidly adapt enterprise resource planning (ERP) systems on both a global and local level. Such adaptations may be complex and may be required to be implemented under strict deadlines.

Due to the considerations above, a number of software applications and systems have been developed to comply with transference tracking and tax laws in various jurisdictions worldwide. Existing software applications and systems can require significant investment in hardware, resources, licensing and support. These applications are often legacy, centralized solutions requiring a multitude of interfaces with internal systems, partners and government agencies. Alternative approaches to existing solutions may result in improved efficiencies for both corporate and government stakeholders.

### SUMMARY OF THE DESCRIPTION

Systems and methods are disclosed that provide for an electronic ledger that uses blockchain technology to authenticate, register, and track electronic transference records for goods and services. A blockchain system is implemented, in one embodiment, as a permissioned, peer-to-peer, decentralized network containing an authorized, verifiable ledger of transaction records that can shared amongst hardware nodes associated with authenticated actors. The decentralized ledger can be used as a substitute for centralized database of electronic transaction records and enables automated tracking and reporting of electronic records to an authoritative, but non-central authority that participates in the transference tracking system blockchain.

One embodiment provides for a computing system comprising an interconnect to couple hardware components within the computing system; a network interface coupled with the interconnect, the network interface to enable a peer-to-peer connection with one or more additional computing systems; a non-transitory machine-readable medium coupled with the interconnect, the non-transitory machine readable medium storing instructions; one or more processors coupled with the interconnect, the one or more processors to execute instructions stored on the non-transitory machine-readable medium, the instructions to cause the one or more processors to establish the peer-to-peer connection with the one or more additional computing systems. In one embodiment the one or more processors are additionally to validate an electronic record of a transaction, the transaction corresponding to a transference of one of physical items and services between transaction participant entities and store an authenticated record of the transaction to a shared database, the shared database distributed via the peer-to-peer connection with the one or more additional computing systems.

One embodiment provides for a non-transitory machine-readable medium storing first instructions which, when executed by one or more processors of a computing system, cause the computing system to perform operations including establishing a peer-to-peer connection with one or more additional computing systems and initializing a virtual machine to execute a set of operations associated with an electronic record of a transaction, the transaction corresponding to a transference of one of physical items and services between transaction participant entities. The operations additionally include receiving a block of a blockchain via the peer-to-peer connection, the block including transaction detail data to be stored within the transaction record. The transaction record can be cryptographically associated with multiple entity identifiers. The multiple entity identifiers can include an entity identifier of a non-central authoritative entity associated with at least one of the one or more additional computing systems. In one embodiment the blockchain stores a database shared with the one or more additional computing systems.

In a further embodiment, the operations additionally include loading a consensus rule associated with the transaction record. The consensus rule can define a set of cryptographic operations to validate the transaction record and authenticate one or more entity identifiers associated with the transaction record. The consensus rule can include operational logic defined by the non-central authoritative entity. A second set of instructions can be derived from the consensus rule. The second set of instructions causes a data processing system to validate the electronic record of the transaction.

One embodiment provides a method of performing any of the operations described herein. Other features of the present embodiments will be apparent from the accompanying drawings and from the detailed description, which follows.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates a computing system in which a blockchain can be used to implement electronic transference tracking services, according to embodiments described herein.

FIG. 2 illustrates additional details of the transference tracking system, according to an embodiment.

FIG. 3 is a block diagram illustrating an exemplary API architecture, which may be used in some embodiments.

FIG. 4A-4B are block diagrams of exemplary API software stacks, according to embodiments.

FIG. 5 is a block diagram of a device architecture, according to an embodiment.

FIG. 6 is a block diagram of one embodiment of a computing system.

FIG. 7 is a flow diagram of logic to process and record electronic transaction records, according to an embodiment.

FIG. 8 illustrates an electronic transference tracking system, according to embodiments described herein.

FIG. 9 illustrates a computing system architecture for transaction validation, according to an embodiment.

FIG. 10 illustrates a transaction record, according to an embodiment.

FIG. 11 illustrates a process to validate transaction record details, according to an embodiment.

### DETAILED DESCRIPTION

In the following detailed description of embodiments, reference is made to the accompanying drawings in which like references indicate similar elements. The accompanying drawings show, by way of illustration, manners in which specific embodiments of the described embodiments can be practiced. The embodiments are described in sufficient detail to enable those skilled in the art to practice the invention. It is to be understood that other embodiments may be utilized and that logical, mechanical, electrical, functional and other changes may be made without departing from the scope of the present disclosure. The following detailed description is, therefore, not to be taken in a limiting sense, as the scope of the present invention is defined only by the appended claims.

Reference in the specification to “one embodiment” or “an embodiment” or “some embodiments” means that a particular feature, structure, or characteristic described in conjunction with the embodiment can be included in at least one embodiment. The appearances of the phrase “embodiment” in various places in the specification do not necessarily all refer to the same embodiment. It should be noted that there could be variations to the flow diagrams or the operations described therein without departing from the embodiments described herein. For instance, operations can be performed in parallel, simultaneously, or in a different order that illustrated.

In some existing invoice-based transaction systems, each participant maintains data and transactions in separate repositories. For example, the separate repositories can include databases for each participant and/or one or more centralized databases. Data such as electronic invoices can be shared via an Electronic Document Interface (EDI), e-mail, Secure FTP, or other electronic methods. Return communications can be received in the same manner. This centralized approach is centered around the essence of “trust” between participants, or rather “mutual mistrust” between the participants. Each participant seeks to maintain control over their respective data. Participants may disallow read or write access to external entities and will accept data only from trusted sources. This existing approach introduces a number of inefficiencies in the electronic invoicing space, such as process delays, cost incurred due to maintenance of information technology infrastructure, security risks, and other related concerns.

Embodiments described herein provide a transference tracking system implemented using a set of distributed digital ledger technologies. The transference tracking system addresses the above concerns while introducing visibility and immutability or transaction records. Furthermore, the transference tracking system can be configured to natively implement fiscal and tax compliance policies. In embodiments described herein, the decentralized digital ledger technologies are implemented using blockchain technology. Blockchain technology enables fast and secure techniques to record, append, view and share data, in contrast to the centralized, relational database approach commonly used by existing systems. Embodiments described herein provide technologies that enable data to be shared securely, in near real-time, without requiring a centralized source of authority. A blockchain structure can be leveraged to meet legal electronic invoicing requirements imposed by some jurisdictions, and can significantly reduce the required localized infrastructure, supporting applications, and resources used by existing transference tracking systems.

The transference tracking system can significantly reduce the localized infrastructure required for meeting legal requirements for commercial transactions, while introducing new capabilities to provide tax and fiscal visibility to government authorities. In one embodiment, the transference tracking system is implemented as a permissioned, peer-to-peer, decentralized network including a distributed blockchain containing authorized and verifiable electronic records of transactions shared amongst authenticated actors. Communication performed between actors is direct and does not pass through a central entity. Due to the decentralized nature, communications performed via the transference tracking system blockchain do not have a single point of failure. Transactions are added and validated based on consensus rules agreed upon by all actors.

The blockchain of the transference transfer system differs from a cryptocurrency-based blockchain in that the transactional value of the blockchain is represented by electronic records. The consensus rules are defined based on authorization logic from an external entity such as a government or authorizing body or any entity managing localized infrastructure rules and regulations associated with a geographic location, business, institution or the like. Additionally, the transference transfer system enables a permissioned blockchain designed for a closed set of actors. Actors within the system include, but are not necessarily limited to corporations, third party logistics (3PL), original equipment manufacturers (OEM), third party product (3PP) partners, resellers, retail stores, freight carriers and forwarders, finance institutions, as well as federal, state and municipal governments. The transference tracking system described herein can be used to implement a validated record for all actors and recognized as immutable truth by government regulatory and audit functions due to the inherent security and integrity built into the system.

### Transference Tracking System Benefits

The transference tracking system described herein can provide a variety of benefits when applied to electronic invoicing systems used within certain regional jurisdictions, such as, but not limited to Central America and South America. In some instances, the transference tracking system can reduce or eliminate localized electronic invoicing infrastructure, applications and resources. The transference tracking system can be used to expand near real-time fiscal and tax compliance and audit reports for corporate partners and government entities, as the blockchain data used by the transference tracking system is verifiably consistent, immutable and available for query using a standardized set of protocols. Reducing or eliminating the need for manual, electronic submission of monthly, quarterly, and/or yearly reports can enable significant efficiency gains by making the relevant jurisdictional governments an authenticated actor with access to blockchain transactions within the system. For example, the transference tracking system described herein can give governments near real-time visibility into corporate partner invoicing transactions, including volume and materials, which can reduce or eliminate the need for third-party vendors of electronic invoicing and reporting services, and the associated third-party access to consumer-related data that is afforded to such third-party vendors. Furthermore, the transference tracking system can decrease the number of logistics failure points, as the blockchain data of the transference tracking system is decentralized and replicated. Additionally, the transference tracking system can enable a reduction in corruption and tax evasion from actors in the transaction system due to the visible and immutable nature of the ledger of electronic transaction records. Furthermore, a multi-jurisdictional transference tracking system can be implemented using multiple blockchains, which can be joined to enable a global view of electronic invoicing and taxation.

The transference tracking system provides particular benefits as a blockchain implemented system. Shared databases are provided, such that electronic invoices, or other electronic transaction records that are used within certain legal and regulatory jurisdictions, can be shared and stored in a distributed manner as validated electronic transaction records within a blockchain. The blockchain of transaction records can then be distributed and shared amongst different actors, creating a distributed, non-centralized database that can be accessed by authorized actors or participants. Multiple writers are enabled, such that different actors can create, access and append transaction records, where an append would create new transaction with a pointer to the original transaction (e.g., a Merkel Tree). Multiple non-trusting writers are able to participate in the system, as the actors share a degree of mutual distrust due to a native interest to secure and manage their own data. Disintermediation is enabled. With agreed consensus rules, no central gatekeeper is required. However, the consensus rules may be based on an authority's request, such as a jurisdictional government. Transaction interaction is enabled, such that transaction records flow from actor to actor in a defined process and serve as inputs and outputs to complementary processes. Regarding transaction validators, the government entity requiring authorization of an electronic transaction record can provide a basis for trust for electronic transaction records, such as, but not limited to electronic transaction records that serve as an authoritative record of a transaction in goods or services within a legal jurisdiction and/or the logic referenced as consensus enabling the creation of an authorized transaction. Every actor or participant within the transference tracking system can then be afforded an opportunity to validate the transaction records. In one embodiment, a majority of actors may be required to validate the transaction records. In one embodiment, all actors associated with a transaction may be required to validate the transaction records. In another embodiment, an authorized government/judicial entity authorizes the creation of transactions based on defined logic and the transactions are merely replicated to actors. Transactions on the transference tracking system blockchain can be used to process a variety of transaction records, such as, but not limited to electronic invoices associated with transactions in goods or services during different stages of the product distribution process (e.g., products, logistics, etc.).

### Blockchain Overview

A blockchain system allows a group of connected computers to maintain a single updated and secure ledger. Blockchain systems are designed such that no trust is required between the participants of the system, as security and reliability are enforced via mathematical functions and program logic executing on the blockchain. When a blockchain transaction is requested, a transaction request is broadcast to a distributed computing network of computing nodes. The network of nodes uses a set of known and pre-determined algorithms to validate the transaction and the status of the participants of the transaction. The transaction can be in reference to a record or contract, including an electronic invoice contract. Verified transactions are combined with other transactions to create a new block of data. The new block of data is added to an existing blockchain, making the transaction permanent and immutable.

The specifics of the implementation of a blockchain technology can vary. However, blockchain technologies, in general, adhere to a set of common principles. Each party on a blockchain has access to the entirety of the distributed database of the blockchain, as well as the complete history of the database. No single party controls the data and each party can verify the records of transaction partners directly, without an intermediary. Additionally, communication occurs directly between peers instead of through a central node. Each node stores and forwards information to all other nodes. Every transaction and its associated value are visible to anyone with access to the system. Each node, or user, on a blockchain has a unique address identifying the node or user, and transactions occur between these blockchain addresses. While users can remain anonymous, corporate to government transactions can be performed based on mutual proof of identity when performing blockchain transactions. Once a transaction is entered in the database and the accounts are updated, the records cannot be altered, as each record is linked to every preceding transaction record. Various algorithms and approaches can be deployed to ensure that the recording on the database is permanent, chronologically ordered, and available to all others on the network. Additionally, the digital nature of the single updated and secure ledger means that blockchain transactions can be programmable and tied to an algorithm or rule, which can be used to automatically trigger transactions between nodes.

The programmable aspect enables a blockchain to be used to facilitate smart contracts, which are programs that can be configured to automatically validate a set of conditions. A smart contract can be created and written as code into the blockchain. The smart contract executes on nodes of the computing system executing the blockchain and monitors a set of conditions associated with the contract. Once the smart contract determines that some set of conditions has been met, the smart contract can automatically trigger the occurrence of some pre-determined event, such as the transfer of a digital asset or document to one or the participants of the smart contract transaction.

### Transference Tracking System Overview

A hardware node associated with an authenticated actor can instantiate a blockchain node through which the actor can perform specific functions based on the actor's role. The transference tracking system offers various protocols and APIs to enable a variety of transactions to be performed. The value of the transference tracking system blockchain is an electronic record to be recorded within the distributed ledger. In the context of the transference tracking system, the electronic record can be validated, and an authenticated record can be stored within a distributed ledger, such as a blockchain. The electronic record can store transaction records, such as electronic invoices, which are commonly used to track and record transactions in certain developing countries. In such countries, electronic invoices serve as a legal document that is required for the movement and transport of goods (e.g., physical items) or for the provision of services. These electronic invoices are commonly required to be registered with the government, often in real-time, before goods can be transported or after services are provided and serve as an important basis for fiscal and tax compliance. For example, in some jurisdictions, taxes for goods and services are declared on the electronic invoice and referenced for reporting and audit purposes.

In jurisdictions that use electronic invoices, the electronic invoices can be defined in an XML format, or other customized format, and communicated to different participant entities using a number of different interfaces. The electronic invoices are communicated from one centralized repository (such as a database) to other centralized repositories using interface methods such as EDI, secure FTP, HTTPS, web services etc. PDF or paper versions of these electronic invoices are often required at specific points in the sales, logistics, repair, and transport process to provide proof of taxes paid and registration with federal, state and municipal governments. Internal Finance departments such as Accounts Payable (AP) receive these electronic invoices to review, approve, process and pay them accordingly. This information feeds internal financial ledger and bookkeeping systems.

The transference tracking system described herein can be used to replace a centralized electronic invoice database with an authenticated and validated electronic ledger stored via a distributed blockchain. Synchronized digital data can be spread across multiple sites, countries, and/or institutions. The transference tracking system offers protocols and APIs for transactions allowing actors to create, view, query, verify and link transactions. Each authenticated actor can instantiate a node on the blockchain of the transference tracking system, providing the actor with access to perform specific functions based on the role associated with the actor. Protocols and APIs are also available to allow external enterprise systems such as ERP, finance and audit systems to submit and query information to and from the transference tracking system. The transference tracking system creates an immutable ledger for electronic transaction records that cannot be altered or changed once the record is authenticated, validated, and committed to the blockchain. Complementary transaction records can be linked to source transactions, providing a digital ledger of the transactions status.

While transactions performed using the transference tracking system may contain personal identification information (PII) of actors associated with an electronic record, in one embodiment personal consumer information (PCI), such as payment information, is not maintained on the blockchain of the transference tracking system. Rather than enabling a tokenized payment gateway, the transference tracking system enables a decentralized invoicing ledger accessible by authenticated actors. Governments and auditors can then view and audit transactions stored via the blockchain. In one embodiment, PCI data can be stored off-chain and a reference to the PCI data can be stored within the TTS blockchain. For example, in one embodiment the transference tracking system can map to other blockchains or systems with API related PCI or identity data. For example, an off-chain reference can be stored within a record of a transaction to reference PCI data without storing such data on the TTS blockchain.

Typically, public blockchains require a form of “energy” in order to process transactions. In the context of cryptocurrency blockchains, energy represents a contribution to an entity hosting a node to provide an incentive for the host to execute transactions via the node (e.g., cryptocurrency that can be derived by “mining” transactions on the cryptocurrency blockchain). For the transference tracking system described herein, in contrast to cryptocurrency blockchains, the value of a transaction lies within the value of the authenticated and validated electronic record associated with the transaction itself. Accordingly, each actor is permissioned based on the assumption that the actor has an inherent interest to process transactions on their respective hardware node and will invest in the hardware, time, electricity, network resources, etc., that are necessary to perform the processing operations of the blockchain. However, as excessively large transactions can introduce latency into the system, in one embodiment a cap can be on the number of operations per block of the blockchain to restrict the growth of the size of transactions, smart contracts, and other associated operations.

Consensus rules serve to ensure that blocks added to the blockchain remain the one and only version of the truth to prevent attacks, forking, and/or misrepresentations of the blockchain. In one embodiment, a consensus rule can include logical operations defined by the mandated authority, such as a Federal, State, or Municipal government. The consensus rule can define how to authenticate an actor (or actor identifier) associated with a transaction, validate data associated with the transaction, and register an electronic record of the transaction. For example, an actor can submit transaction data, such as electronic invoice data, to the transference tracking system. The transference tracking system can then invoke government specified logic defined within a consensus rule to validate and authorize the transaction. This can be accomplished by a compute node, for example, by invoking a web service or smart contract with transaction data and transaction logic associated with the transaction data. The mandated authority or smart contract returns an authentication or protocol indicating successful authorization, which serves as a consensus.

When a transaction is submitted to the transference tracking system, nodes within the system can replicate the transaction based on a consensus rule which, in one embodiment, is acceptance from the authority in question. A smart contract can be executed on behalf of the transaction, which performs operations to determine whether the transaction conforms with the consensus rule. Where the consensus rule specifies an acceptance from a non-central authority, output of the smart contract can represent validation and authorization by such authority. An authentication number or protocol number output by the smart contract can be recorded and used as a base for a hash block associated with the transaction. In one embodiment, the consensus rules can be tailored specifically to support electronic invoicing systems used by certain geographic regions. However, the consensus rules can be tailored for use within different transaction systems and different jurisdictions.

To address sending order issues in replication, the known Byzantine Fault Tolerance (BFT) consensus rule can be applied subsequent to electronic record authorization. As transactions may be subject to loss, damage, latency and repetition, the sending order may not necessarily be consistent with the receiving order of messages etc. therefore BFT can be used to ensure a minimum number of nodes reach consensus on the order of transactions before appending them to the shared ledger. As the transference tracking system has limited actors, the minimum number of nodes may be small. However, the transference tracking system is not limited to one central authority.

Specific details of implementations of the transference tracking system can vary. However, each implementation has common features regarding identity and auditability, privacy and confidentiality, consensus rules, performance, and scalability. Pseudonymity can be present in some implementations, such that actors can invoke transactions without disclosing their identity, while enabling a mechanism to trace back the actor to the transaction for audit purposes. In a transference tracking system implementation, each actor has a specific role and may be known to each other. However, it is also possible to implement pseudonymity if it is desirable for an actor to be able to avoid disclosure of the identity of its partners to one another. Assuming there is a competitive interest for actors to not be aware of other actors (e.g., carriers, OEMs etc.) then specific roles can be created which will drive or define the information each actor can access on the transference tracking system. Furthermore, the transference tracking system can provide capabilities to maintain the confidentiality of information that may be considered confidential, such as transaction patterns or terms and conditions.

### Smart Contracts

A distributed computing system implementing the transference tracking system can provide a smart contract system that can be used to streamline electronic record processing between companies (e.g., multinational, multijurisdictional corporations) and jurisdictional governments. A smart contract can be implemented as a program that resides on the blockchain and that can be executed by nodes connected to the blockchain network of the transference tracking system. The program code of the smart contract can perform any number of transference tracking related activities, such as, but not limited to verifying and/or tracking the presence or movement of goods along a supply chain, verifying that a service or transaction has been performed, verifying inventory of manufactured goods, and tracking the status of a service, such as the physical transport of goods from one location to another location. The smart contact can be configured to conditionally execute upon the occurrence of some pre-determined action or event. During execution, the smart contract can track the performance of some associated transference operation or verify the occurrence of some pre-defined transference action. The smart contract can contain a set of rules (e.g., consensus rules) that can be validated by all actors within the system. The smart contract can use the consensus rules, for example, to verify that an associated transference action or transaction (e.g., manufacture, shipment, delivery, etc.) has been performed. In one embodiment, the consensus rules can additionally include the automatic generation and submission of reports to government entities tasked with overseeing transference actions tracked by the transference tracking system.

### Actor Authentication

Where actors in the transference tracking system are authenticated, then identity registration can be maintained, with the ability to establish and revoke identities. Instead of using a centralized authority entity, one or more peers can be enabled to establish, maintain, and revoke identities. Where the jurisdiction establishes the government as a regulating body, the government, as a peer within the transference tracking system, can register actors within their respective systems and authenticate such actors accordingly, assuming the government has the ability to generate public and private security keys. A government can establish a system of actor registration, or leverage an established system of corporate registration, and associate a corporate registration number with a digital certificate that can be used to verify the identity of an actor within the system.

Using the nation of Brazil as an example, all entities with operations in Brazil are required to have a company registration number with the government, namely a CNPJ (Cadastro Nacional da Pessoa Juridica). The CNPJ can be used by the government to register companies and to issue those companies a digital certificate for use as authentication when authorizing electronic records, submitting fiscal reports, or other transaction related operations. The CNPJ and digital certificate can serve as the base for authentication of actors on a transference tracking system implementation for Brazil.

### Use Case Samples

Specific problem statements can be addressed by the transference tracking system. In one sample scenario, an online sale in Brazil for a product is made for a consumer in Brazil, the order is submitted to an internal ERP solution for the corporation providing the product, an electronic record of the transaction is created, authorized with the government, and sent to a local carrier for transport and delivery. The actors in such system include an end consumer in Brazil, the consumer goods supplier company (e.g., Apple Inc.) a distribution center (DC), a logistics carrier, and a Brazilian state government (e.g., Local Sao Paulo State government), and the transference tracking system blockchain. In the sample use case below, the key benefits provided by the transference tracking system are within the hardware and software systems, rather than the financial and commercial concepts enabled by the transference tracking system.

First, a Brazil End Consumer submits order for a product on a corporate Brazilian localized online website. Next, an order is inducted into a purchasing interface for an ERP system, which facilitates the creation of a sales order and delivery document. Payment for the order is verified and the order is made ready for invoicing. The ERP system then sends the sales order information required for invoicing to the transference tracking system via an Application Programming Interface (API) or similar interface. The API enables the ERP system to remotely execute a function on the transference tracking system.

Next, the transference tracking system can invoke a smart contract and execute consensus logic to authorize electronic records (e.g., via web service or by executing internal logic). Electronic records are authorized and registered, protocol numbers are returned, and the transference tracking system can create a new transaction for the electronic records. The authorized electronic records can be replicated, potentially within seconds depending on network latency, and can appear on blockchain node instances at the consumer goods supplier, distribution center, logistics carrier, and/or government entity.

Once the transference tracking system blockchain node instance at the distribution center receives the authorized electronic records, the distribution center can begin processing the order immediately. For example, the distribution center can access the transference tracking system and print a paper copy of electronic records. The paper copy can include a scannable barcode or image code, such as a QR code. The logistics carrier, having also received the electronic invoice at a local instance of the transference tracking system blockchain, can review and verify delivery information and accept the product from the distribution center for delivery. In some jurisdictions, agents of a government authority may periodically stop a shipment in transit to confirm that the appropriate taxes have been paid on the shipment. In this instance, the authority can scan a bar code, image code (e.g., QR code), or other scannable code generated by the transference tracking system to enable the authority to access the transference tracking system, which can report whether the shipment is authentic and whether the appropriate taxes have been paid.

Having been allowed to proceed by the local authority, the logistics carrier can deliver the product to the end consumer and update the transaction in the blockchain to indicate that the product has been delivered. Subsequently, the end consumer can query the transaction using a personal identifier information number (e.g., a CPF number as in Brazil) to view the electronic record. The end consumer may then print the record if needed. In one embodiment, as a precondition to the above operation, actors within the transference tracking system can be authenticated, with each actor hosting an instance of the transference tracking system blockchain. In such embodiment, actor owned computing systems can be authenticated in some manner before being granted access to the transference tracking system blockchain.

An additional sample use case can be considered in the context of financial reporting. In such scenario, a partner corporation may be required to produce a monthly accounting report to a jurisdictional government to indicate sales and taxes paid for the previous month. Again, using the example of Brazil, a scenario can be realized in which Brasil Receita Federal (RFB) initiates SPED fiscal and accounting reports themselves on a specific recurring monthly date by initiating a smart contract that identifies transactions for the month in question and produces sales and tax reports for their review. RFB reviews these reports and communicates any concerns or questions directly to the originating actor. If there is a tax calculation error, the respective actor can review and possibly re-calculate the tax using the actor ERP system. The actor can then submit a new transaction associated with the original transaction. The new transaction can perform an append operation to the original transaction, thus reflecting the new tax values. RFB could rerun the smart contract, which recognizes the new transaction and updates SPED reports accordingly. All information used for fiscal and tax compliance reporting can be integrated into the transference tracking system, which can be configured to retrieve any additional information needed from corporate ERP systems. The transference tracking system and associated blockchain, as described above, can be implemented using the software and hardware architecture described below.

### Exemplary Computing Systems

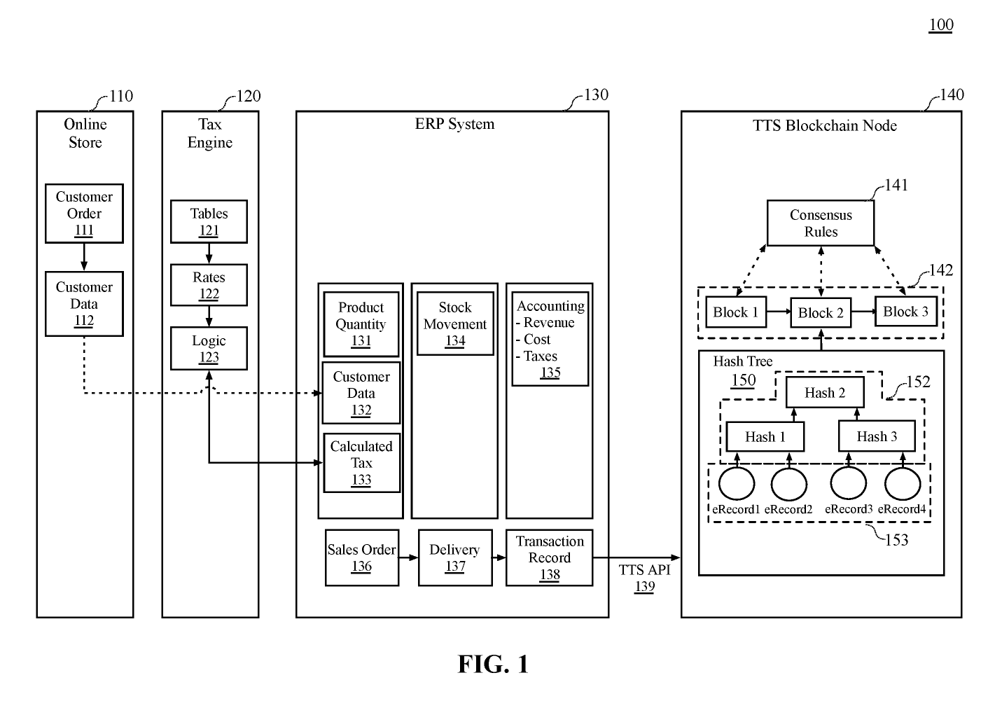

FIG. 1 illustrates a computing system 100 in which a blockchain associated with a transference tracking system can be used to implement electronic invoicing services, according to embodiments described herein. In one embodiment, the computing system 100 includes an online store 110, tax engine 120, enterprise resource management system (ERP system 130), and a transference tracking system (TTS) blockchain node 140. The online store 110, tax engine 120, and ERP system 130 can each represent a server device or cluster of server devices coupled to a network. The server devices can be physical servers, virtual servers, or a cloud-based server system within one or more datacenters. In one embodiment, the tax engine 120 can be associated with a government financial or regulatory agency that calculates a tax for transactions performed within the system, or can be associated with a private, non-governmental organization (e.g., tax or accounting organization, geographical local authority, one of an educational, religious, sports, arts, news organization or the like) that can be contracted to provide tax, accounting, or transference tracking services. The TTS blockchain node 140 can be a server device, workstation device, or cluster or physical or virtual server or workstation devices associated with an actor or entity within the transference tracking system. In one embodiment, each actor within the transference tracking system will have an associated instance of the TTS blockchain node 140.

In one embodiment, the online store 110 can receive a customer order 111, along with customer data 112 associated with the customer order 111. The customer order 111 and customer data 112 can be processed by the tax engine 120. The tax engine 120 includes a set of data tables 121 and tax rates 122 that are used by processing logic 123 to perform a tax calculation for the customer order 111. The online store 110 can directly or indirectly provide transaction data including the customer order 111 and customer data 112 to the ERP system 130, which can store the transaction information as ERP customer data 132. The processing logic 123 of the tax engine 120 can communicate a calculated tax 133 for the transaction to the ERP system 130. The transaction data (e.g., ERP customer data 132, calculated tax 133) for each transaction can be used to update records on product quantity 131, stock movement 134, and accounting data 135 (e.g., revenue, cost, taxes, etc.) for the enterprise. The ERP system 130 can then generate data and/or electronic documentation including sales order data 136, delivery information 137, and a transaction record 138, and submit this data via the TTS API 139 to a TTS blockchain node 140. In the illustrated computing system 100, the illustrated TTS blockchain node 140 is the TTS blockchain node 140 associated with the enterprise goods supplier that will provide one or more products or services used to satisfy the transaction at the online store 110 that is associated with the customer order 111 and customer data 112.

The TTS blockchain node 140 can receive data associated with the transaction record 138 via the TTS API 139 and process the transaction record 138 via one or more blockchain operations performed at the TTS blockchain. The transaction can be added to transference tracking system and validated based on a set of consensus rules 141 that are agreed upon by all actors. The specifics of the consensus rules 141 can be defined programmatically and executed as a program in a distributed manner across multiple instances of the TTS blockchain node 140. For example, in one embodiment the transaction record 138 can be processed as a smart contract on the blockchain of the transference tracking system.

In one embodiment, the TTS blockchain node 140 processes a set of multiple blocks 142 (e.g., Block 1, Block 2, Block 3) arranged in a blockchain. Each block in the set of multiple blocks 142 can include the root node of a hash tree 150 (e.g., Merkel Tree). The hash tree 150 is a data structure of linked hash values 152 (e.g., hash 1-hash 3), where the leaves of the hash tree 150 are a set of electronic transaction records 153 (eRecord1-eRecord4). The TTS blockchain node 140 can be used to execute transactions based on the rules and operation specified within a smart contract. The transference tracking system blockchain can be used to execute smart contracts in a distributed manner across nodes provided by actors that use the system to facilitate electronic invoicing.

Specific implementation details of the blockchain of the transference tracking system can vary across embodiments. In one embodiment, each block in the set of multiple blocks 142 within the blockchain is identified by a hash value that is generated by a hash function, which can be one of various hash functions including, but not limited to the SHA256 cryptographic hash algorithm. The hash value can be generated by applying a hash function to the header data of the block. The blocks 142 can be linked in a chain, with each block having a link to a previous block. The previous block (e.g., parent block) can be identified by the hash value of the previous block, which can be stored in the header of the current block. A sequence of hash values can be used to link each block, back to the original block of the blockchain.

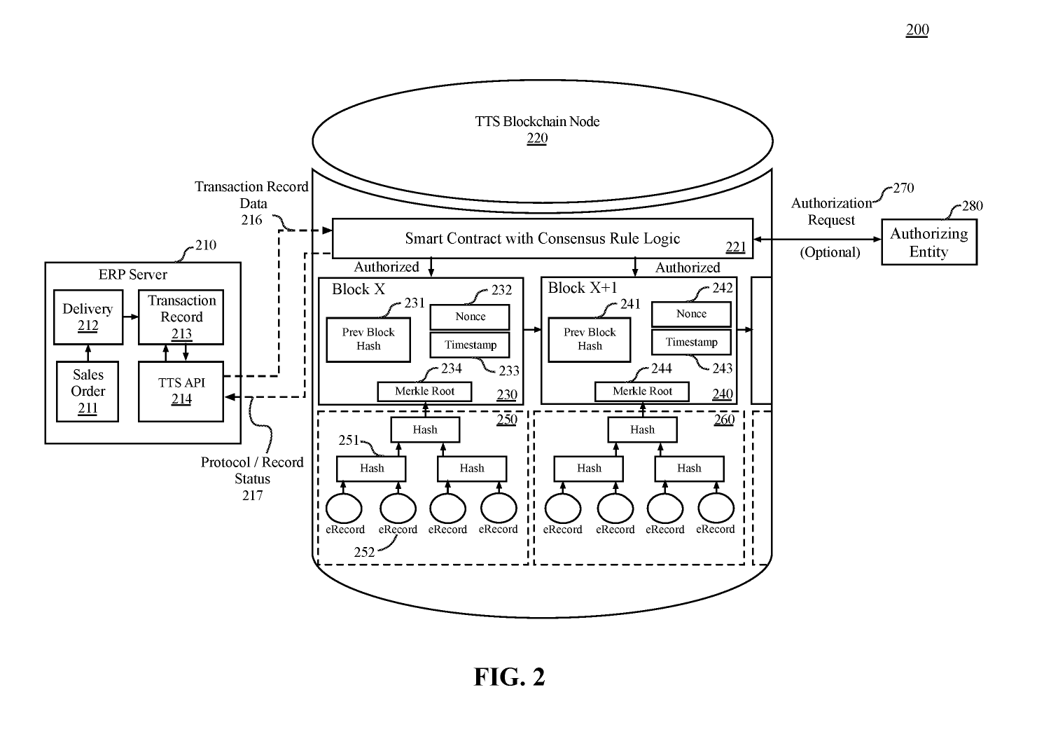

The distributed computing systems that implement the TTS blockchain can execute one or more smart contracts for each transaction in the set of electronic transaction records 153. The type of execution environment enabled on the TTS blockchain node 140 can vary based on embodiment. In one embodiment, a TTS blockchain node 140 can provide a virtual machine that enables access to a general-purpose decentralized compute environment in which smart contracts can execute. In one embodiment, the TTS blockchain node 140 provides a streamlined and optimized smart contract execution environment with a feature set that is tailored to execute smart contracts related to electronic records of transactions. For example, the transference tracking system can provide an execution environment that is tailored to enable a simplified programming model for smart contracts that provides predefined primitive functions, objects, and/or data structures to facilitate operations for specific actors within the transference tracking system. The transference tracking system can provide objects that are tailored for use by specific actors in the system, such as an end consumer, a goods supplier, a distribution center, a logistics carrier, and local, state, and national governments. The transference tracking system can also provide primitives to facilitate actor authentication and, in some implementations, enable pseudonymity for specific actors, such that actors can invoke transactions without disclosing their identity. However, for audit purposes, the transference tracking system enables transactions to be traced back to the actors participating in the transaction. Additional data regarding the transference tracking system is provided in FIG. 2 below.

FIG. 2 illustrates additional details of the transference tracking system 200, according to an embodiment. In one embodiment, the transference tracking system 200 includes an enterprise resource planning server (ERP server 210) communicatively coupled with a compute node for the transference tracking system blockchain (TTS blockchain node 220). The TTS blockchain node 220 can be the same or similar to the TTS blockchain node 140 of FIG. 1. The ERP server 210 can include a sales order module 211, a delivery module 212, and a transaction record module 213, a TTS API module 214. Each module on the ERP server 210 can be implemented via executable instructions stored on a non-transitory computer or machine readable a software module The TTS API module 214 can enable communication of transaction record data 216 to the TTS blockchain node 220, which can process the transaction record data 216 via a smart contract 221 that contains consensus rule logic. The transaction record data 216, in one embodiment, is transaction detail data that specifies details of a transaction to be tracked, such as the actors or participants in the transaction, the type of transaction (e.g., goods, logistics services, etc.), a value associated with the transaction, and taxes data associated with the transaction, such as taxes paid for the transaction. The smart contract 221 can determine, based on the consensus rule logic, whether to authorize a smart contract, where the consensus rule logic has been pre-determined and agreed upon by all actors within the transference tracking system 200. In one embodiment, the authorization process can be performed entirely by the smart contract 221 within the TTS blockchain node 220 using the consensus rule logic. In one embodiment, the smart contract 221 can optionally send an authorization request 270 to an authorizing entity 280, which can authorize the transaction record data 216 or provide additional information and/or credentials that can be used to authorize the transaction record data 216. In one embodiment, the authorizing entity can receive the authorization request 270 can respond to the authorization request as a transaction executed on an instance of the blockchain node associated with the authorizing entity 280 (e.g., via on-site compute resources or via remote datacenter resources).

Status with respect to the transference tracking protocol, as well as status with respect to a given electronic record, can be communicated to the ERP server 210 in the form of protocol/record status 217. Protocol status information can be handled via the TTS API module 214, with data transmission errors being handled according to protocol specifications. Record status information can be communicated to the transaction record module 213. For example, if transmission of the transaction record data 216 results in the authorization or rejection of the transaction record, the authorization status can be received via the TTS API module 214. When the transaction record is authorized, the authorized transaction record, or authorization status for the invoice, can be recorded via the transaction record module 213. In one embodiment, the transaction record module 213 can output an electronically signed transaction record document, such as, in one embodiment, a cryptographically signed electronic record. In one embodiment, transaction record data 216 that is not authorized by the smart contract 221 can be dropped by the transference tracking system 200. In one embodiment, the transference tracking system can be configured to record transaction record rejections to the blockchain.

When an electronic transaction record is authorized, and in some embodiments, when the electronic transaction record is rejected, the transaction record data and authorization status can be recorded to the transference tracking system blockchain, which creates secure, distributed, and cryptographically authorized ledger of electronic transaction record transactions. As each actor in the system can have role appropriate access to the transference tracking system blockchain, allowing recorded transactions to be automatically accessible to the various actors, as needed. The blockchain includes a set of multiple blocks (Block X, Block X+1), which can be similar to the set of multiple blocks 142 of FIG. 1.

Each block within the blockchain (e.g., Block X, Block X+1) contains a header 230, 240 that includes multiple fields of data. The specific header information for a block can vary across environments, depending on features and optimizations selected for the blockchain implementation. In one embodiment, the header 230, 240 of each block can include a parent hash value (e.g., previous block hash 231, 241) that identifies the parent block of the block, a timestamp 233, 243, which is associated with the creation time of the block, and a nonce 232, 242 that is provided as input to cryptographic hash functions that generate hash values for the block and/or hash values within the hash tree (e.g., hash tree 250, hash tree 260) associated with the block. In some embodiments, each header 230, 240 can also include additional information for the block, such as a record identifier that identifies an electronic transaction record associated with the block. In one embodiment, each block can have an energy limit field that contains a value identifying a limit on blockchain energy (e.g., number or size of computational operations) that can be expended on the block. The block head can also contain a field that specifies an amount of blockchain energy expended on the block. The block header can also contain a pointer to a list of computational operations associated with the block. Each computational operation can include program instructions or code that is executed on the computing nodes that operate the blockchain of the transference tracking system.

In one embodiment, each block includes a root of a hash tree 250, 260, (e.g., Merkle Root 234, 244). The hash tree 250, 260 can be a Merkle tree, which is a tree data structure that can be used to store hash data that identifies and/or authenticates data blocks associated with a set of electronic records. For example, each leaf node of the hash tree 250, 260 can be a hash value generated from an electronic record (e.g., eRecord 252), and data associated with the electronic record, such as a protocol identifier or authentication identifier. That hash value can then be used as an identifier for the electronic record. Every non-leaf node in the tree is labeled with the cryptographic hash (e.g., hash 251) of the labels of its child nodes. The hash tree 250, 260, within each block, enables electronic transaction records to be stored in a secure manner. The node and transaction record data are accessible to actors having the cryptographic functions and data that is used to access the relevant data within the blockchain. The hash values can also be used to ensure that the electronic record data has not been modified within the ledger. For example, a Merkle proof can be performed on hash values on the branch of a tree referencing an electronic record to verify that the electronic record is correctly and validly positioned within the tree.

### Exemplary API Architectures

Embodiments described herein include one or more application programming interfaces (APIs) in an environment in which calling program code interacts with other program code that is called through one or more programming interfaces. Various function calls, messages, or other types of invocations, which further may include various kinds of parameters, can be transferred via the APIs between the calling program and the code being called. In addition, an API may provide the calling program code the ability to use data types or classes defined in the API and implemented in the called program code.

An API allows a developer of an API-calling component (which may be a third-party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some embodiments, the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (e.g., not exposed) and provide a subset of the first set of functions and also provide another set of functions, such as testing or debugging functions which are not in the first set of functions. In other embodiments, the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program to use the services provided by a Software Development Kit (SDK) library. In other embodiments, an application or other client program may use an API provided by an Application Framework. In these embodiments, the application or client program may incorporate calls to functions or methods provided by the SDK and provided by the API or use data types or objects defined in the SDK and provided by the API. An Application Framework may in these embodiments provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low-level logic that executes in part on the hardware component.

The API-calling component may be a local component (e.g., on the same data processing system as the API-implementing component) or a remote component (e.g., on a different data processing system from the API-implementing component) that communicates with the API-implementing component through the API over a network. It should be understood that an API-implementing component may also act as an API-calling component (e.g., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however, the API may be implemented in terms of a specific programming language. An API-calling component can, in one embedment, call APIs from different providers such as a set of APIs from an OS provider and another set of APIs from a plug-in provider and another set of APIs from another provider (e.g. the provider of a software library) or creator of the another set of APIs.

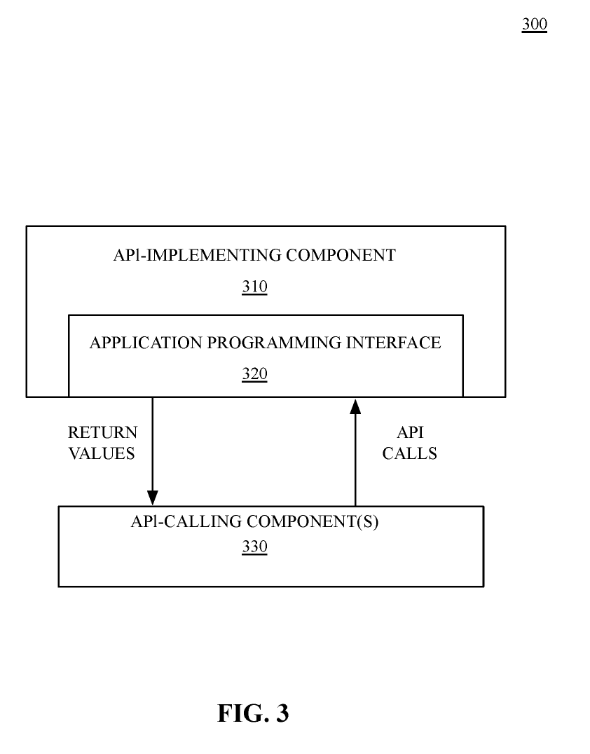

FIG. 3 is a block diagram illustrating an exemplary API architecture, which may be used in some embodiments. As shown in FIG. 3, the API architecture 300 includes the API-implementing component 310 (e.g., an operating system, a library, a device driver, an API, an application program, software or other module) that implements the API 320. The API 320 specifies one or more functions, methods, classes, objects, protocols, data structures, formats and/or other features of the API-implementing component that may be used by the API-calling component 330. The API 320 can specify at least one calling convention that specifies how a function in the API-implementing component receives parameters from the API-calling component and how the function returns a result to the API-calling component. The API-calling component 330 (e.g., an operating system, a library, a device driver, an API, an application program, software or other module), makes API calls through the API 320 to access and use the features of the API-implementing component 310 that are specified by the API 320. The API-implementing component 310 may return a value through the API 320 to the API-calling component 330 in response to an API call.

It will be appreciated that the API-implementing component 310 may include additional functions, methods, classes, data structures, and/or other features that are not specified through the API 320 and are not available to the API-calling component 330. It should be understood that the API-calling component 330 may be on the same system as the API-implementing component 310 or may be located remotely and accesses the API-implementing component 310 using the API 320 over a network. While FIG. 3 illustrates a single API-calling component 330 interacting with the API 320, it should be understood that other API-calling components, which may be written in different languages (or the same language) than the API-calling component 330, may use the API 320.

The API-implementing component 310, the API 320, and the API-calling component 330 may be stored in a machine-readable medium, which includes any mechanism for storing information in a form readable by a machine (e.g., a computer or other data processing system). For example, a machine-readable medium includes magnetic disks, optical disks, random access memory; read only memory, flash memory devices, etc.

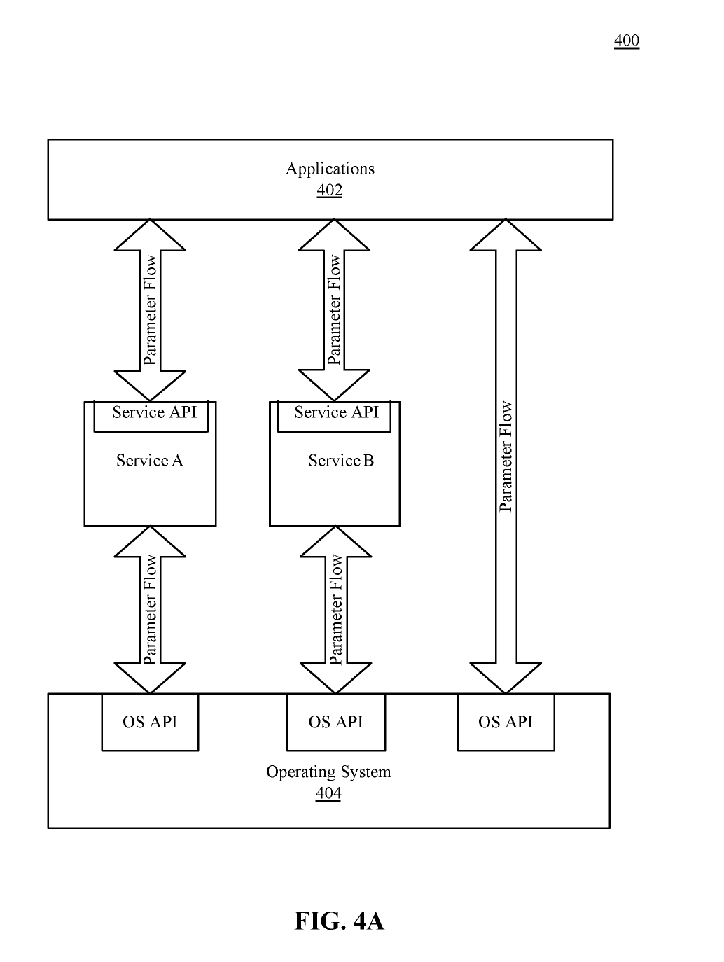

FIG. 4A-4B are block diagrams of exemplary software stacks 400, 410, according to embodiments. FIG. 4A shows an exemplary software stack 400 in which applications 402 can make calls to Service A or Service B using Service API and to Operating System 404 using an OS API. Additionally, Service A and Service B can make calls to Operating System 404 using several OS APIs.

FIG. 4B shows an exemplary software stack 410 including Application 1, Application 2, Service 1, Service 2, and Operating System 404. As illustrated, Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

### Exemplary Device Architectures

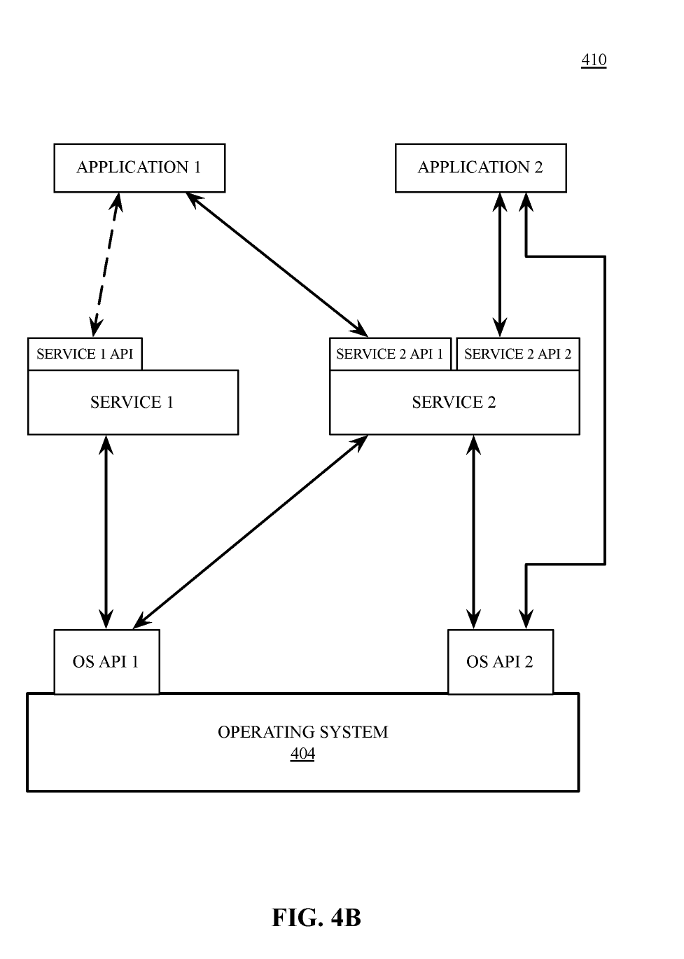

FIG. 5 is a block diagram of device architecture 500, according to an embodiment. The device architecture 500 includes a memory interface 502, a processing system 504 including one or more data processors, image processors and/or graphics processing units, and a peripherals interface 506. The various components can be coupled by one or more communication buses or signal lines. The various components can be separate logical components or devices, or can be included in one or more integrated circuits, such as in a system on a chip (SoC) integrated circuit.

The memory interface 502 can be coupled to memory 550, which can include high-speed random-access memory such as static random-access memory (SRAM) or dynamic random-access memory (DRAM) and/or non-volatile memory, such as but not limited to flash memory (e.g., NAND flash, NOR flash, etc.).

The peripherals interface 506 can couple with an interconnect, such as a bus or fabric interconnect, to which the processing system 504 and memory interface 502 are connected. In one embodiment, sensors, devices, and subsystems can be coupled to the peripherals interface 506 to facilitate multiple functionalities. For example, a motion sensor 510, a light sensor 512, and a proximity sensor 514 can be coupled to the peripherals interface 506 to facilitate the mobile device functionality. Other sensors 516 can also be connected to the peripherals interface 506, such as a positioning system (e.g., GPS receiver), a temperature sensor, a biometric sensor, or other sensing device, to facilitate related functionalities. A camera subsystem 520 and an optical sensor 522, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 524, which can include radio frequency receivers and transmitters and/or optical (e.g., infrared) receivers and transmitters. The specific design and implementation of the wireless communication subsystems 524 can depend on the communication network(s) over which a mobile device is intended to operate. For example, a mobile device including the illustrated device architecture 500 can include wireless communication subsystems 524 designed to operate over a GSM network, a CDMA network, an LTE network, a Wi-Fi network, a Bluetooth network, or any other wireless network. In particular, the wireless communication subsystems 524 can provide a communications mechanism over which a client browser application can retrieve resources from a remote web server.

An audio subsystem 526 can be coupled to a speaker 528 and a microphone 530 to facilitate voice-enabled functions, such as voice recognition, voice replication, digital recording, and telephony functions.

The I/O subsystem 540 can include a touch screen controller 542 and/or other input controller(s) 545. The touch screen controller 542 can be coupled to a touch sensitive display system 546 (e.g., touch-screen). The touch sensitive display system 546 and touch screen controller 542 can, for example, detect contact and movement and/or pressure using any of a plurality of touch and pressure sensing technologies, including but not limited to capacitive, resistive, infrared, and surface acoustic wave technologies, as well as other proximity sensor arrays or other elements for determining one or more points of contact with a touch sensitive display system 546. Display output for the touch sensitive display system 546 can be generated by a display controller 543. In one embodiment, the display controller 543 can provide frame data to the touch sensitive display system 546 at a variable frame rate.

In one embodiment, a sensor controller 544 is included to monitor, control, and/or processes data received from one or more of the motion sensor 510, light sensor 512, proximity sensor 514, or other sensors 516. The sensor controller 544 can include logic to interpret sensor data to determine the occurrence of one of more motion events or activities by analysis of the sensor data from the sensors.

In one embodiment, the I/O subsystem 540 includes other input controller(s) 545 that can be coupled to other input/control devices 548, such as one or more buttons, rocker switches, thumb-wheel, infrared port, USB port, and/or a pointer device such as a stylus, or control devices such as an up/down button for volume control of the speaker 528 and/or the microphone 530.

In one embodiment, the memory 550 coupled to the memory interface 502 can store instructions for an operating system 552, including portable operating system interface (POSIX) compliant and non-compliant operating system or an embedded operating system. The operating system 552 may include instructions for handling basic system services and for performing hardware dependent tasks. In some implementations, the operating system 552 can be a kernel.

The memory 550 can also store communication instructions 554 to facilitate communicating with one or more additional devices, one or more computers and/or one or more servers, for example, to retrieve web resources from remote web servers. The memory 550 can also include user interface instructions 556, including graphical user interface instructions to facilitate graphic user interface processing.

Additionally, the memory 550 can store sensor processing instructions 558 to facilitate sensor-related processing and functions; telephony instructions 560 to facilitate telephone-related processes and functions; messaging instructions 562 to facilitate electronic-messaging related processes and functions; web browser instructions 564 to facilitate web browsing-related processes and functions; media processing instructions 566 to facilitate media processing-related processes and functions; location services instructions including GPS and/or navigation instructions 568 and Wi-Fi based location instructions to facilitate location based functionality; camera instructions 570 to facilitate camera-related processes and functions; and/or other software instructions 572 to facilitate other processes and functions, e.g., security processes and functions, and processes and functions related to the systems. The memory 550 may also store other software instructions such as web video instructions to facilitate web video-related processes and functions; and/or web shopping instructions to facilitate web shopping-related processes and functions. In some implementations, the media processing instructions 566 are divided into audio processing instructions and video processing instructions to facilitate audio processing-related processes and functions and video processing-related processes and functions, respectively. A mobile equipment identifier, such as an International Mobile Equipment Identity (IMEI) 574 or a similar hardware identifier can also be stored in memory 550.

Each of the above identified instructions and applications can correspond to a set of instructions for performing one or more functions described above. These instructions need not be implemented as separate software programs, procedures, or modules. The memory 550 can include additional instructions or fewer instructions. Furthermore, various functions may be implemented in hardware and/or in software, including in one or more signal processing and/or application specific integrated circuits.

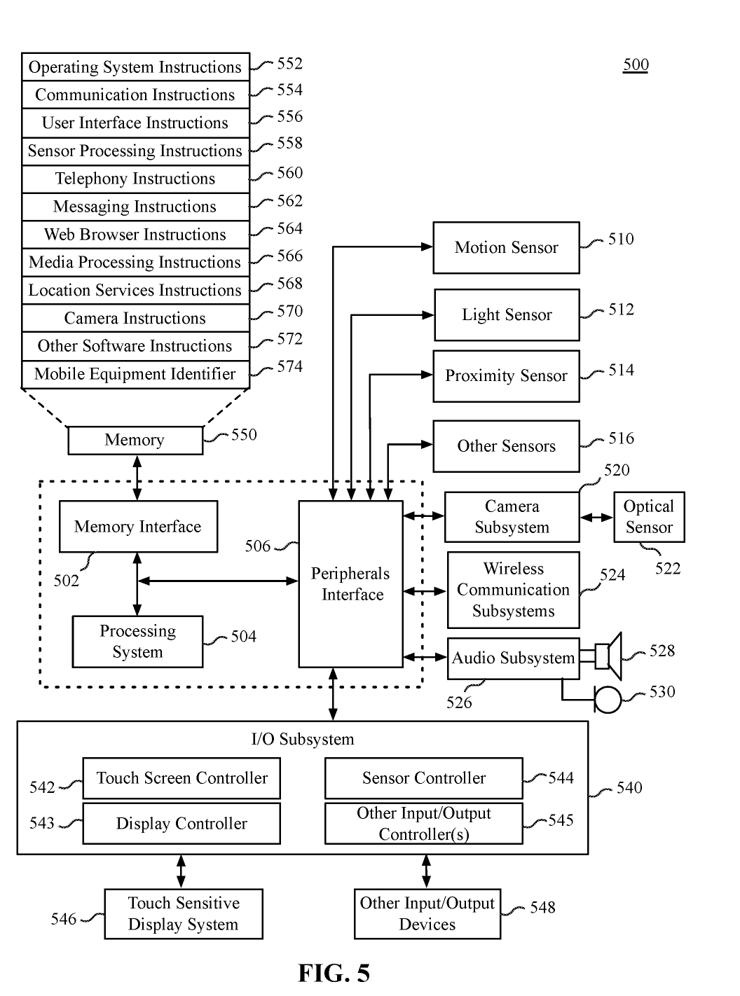

FIG. 6 is a block diagram of one embodiment of a computing system 600. The computing system illustrated in FIG. 6 is intended to represent a range of computing systems (either wired or wireless) including, for example, desktop computer systems, laptop computer systems, tablet computer systems, cellular telephones, personal digital assistants (PDAs) including cellular-enabled PDAs, set top boxes, entertainment systems or other consumer electronic devices. Alternative computing systems may include more, fewer and/or different components. The computing system of FIG. 6 may be used to provide the computing device and/or the server device.

Computing system 600 includes bus 635 or other communication device to communicate information, and processor(s) 610 coupled to bus 635 that may process information.

While computing system 600 is illustrated with a single processor, computing system 600 may include multiple processors 610 (and/or co-processors). Computing system 600 further may include random access memory (RAM) or other dynamic storage device (referred to as main memory 620), coupled to bus 635 and may store information and instructions that may be executed by processor(s) 610. Main memory 620 may also be used to store temporary variables or other intermediate information during execution of instructions by processor(s) 610.

Computing system 600 may also include read only memory (ROM) 630 and/or another data storage device 640 coupled to bus 635 that may store information and instructions for processor(s) 610. Data storage device 640 may be coupled to bus 635 to store information and instructions. Data storage device 640 such as flash memory or a magnetic disk or optical disc and corresponding drive may be coupled to computing system 600.

Computing system 600 may also be coupled via bus 635 to display device 650 to display information to a user. Computing system 600 can also include an alphanumeric input device 660, including alphanumeric and other keys, which may be coupled to bus 635 to communicate information and command selections to processor(s) 610. Another type of user input device is cursor control 670, such as a touchpad, a mouse, a trackball, or cursor direction keys to communicate direction information and command selections to processor(s) 610 and to control cursor movement on display device 650. Computing system 600 may also receive user input from a remote device that is communicatively coupled to computing system 600 via one or more network interface(s) 680.

Computing system 600 further may include one or more network interface(s) 680 to provide access to a network, such as a local area network. Network interface(s) 680 may include, for example, a wireless network interface having antenna 685, which may represent one or more antenna(e). Computing system 600 can include multiple wireless network interfaces such as a combination of Wi-Fi, Bluetooth®, near field communication (NFC), and/or cellular telephony interfaces. Network interface(s) 680 may also include, for example, a wired network interface to communicate with remote devices via network cable 687, which may be, for example, an Ethernet cable, a coaxial cable, a fiber optic cable, a serial cable, or a parallel cable.

In one embodiment, network interface(s) 680 may provide access to a local area network, for example, by conforming to IEEE 802.11 b and/or IEEE 802.11 g standards, and/or the wireless network interface may provide access to a personal area network, for example, by conforming to Bluetooth standards. Other wireless network interfaces and/or protocols can also be supported. In addition to, or instead of, communication via wireless LAN standards, network interface(s) 680 may provide wireless communications using, for example, Time Division, Multiple Access (TDMA) protocols, Global System for Mobile Communications (GSM) protocols, Code Division, Multiple Access (CDMA) protocols, Long Term Evolution (LTE) protocols, and/or any other type of wireless communications protocol.

Computing system 600 can further include one or more power sources 605 and one or more power measurement systems 645. Power sources 605 can include an AC/DC adapter coupled to an external power source, one or more batteries, one or more charge storage devices, a USB charger, or other power source. Power measurement systems include at least one voltage or amperage measuring device that can measure power consumed by the computing system 600 during a predetermined period of time. Additionally, one or more power measurement systems can be included that measure, e.g., power or energy consumed by a display device, cooling subsystem, Wi-Fi subsystem, or other frequently used subsystem and/or subsystem having a high-power consumption.

### Exemplary Operational Logic

Various logic transactions can be performed using the software and hardware architectures described herein to implement the goals of the transference tracking system as described herein. These transactions can be implemented by a computing system having one or more processors, such as the computing system 600 of FIG. 6 or a computing system having the device architecture 500 of FIG. 5. For example, in one embodiment transactions can be performed on multiple compute nodes or multiple clusters of compute nodes, each compute node or cluster of compute nodes associated with a permissioned actor within a transference tracking system implementation. An exemplary compute node associated with one embodiment is a computing system having an interconnect to couple hardware components within the computing system and a network interface coupled with the interconnect. The network interface can enable a peer-to-peer connection with one or more additional computing systems, where the one or more additional computing systems can represent additional computing systems with a cluster or a computing system within an additional cluster. The computing system can include a non-transitory machine-readable medium coupled with the interconnect, where the non-transitory machine readable medium stores instructions for execution by one or more processors of the computing system. The one or more processors can be coupled with the interconnect and configured to execute instructions stored on the non-transitory machine-readable medium. The instructions can be stored in a shared library that includes functions, objects, primitives, data types, and other data to enable the computing system to access a transference tracking system blockchain as described herein. In one embodiment, the instructions can cause the one or more processors to perform a process as in FIG. 6 below.

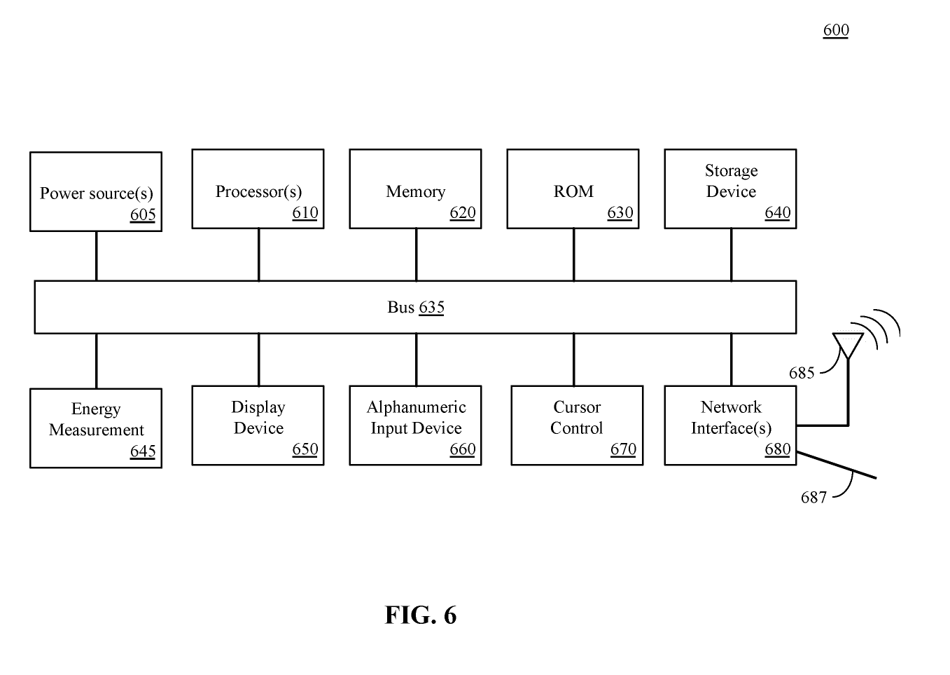

FIG. 7 illustrates a process 700 performed on an TTS blockchain node, according to embodiments described herein. In one embodiment, the process 700 causes one or more processors of a computing node to establish a peer-to-peer connection with one or more additional computing systems, as shown at block 701. At block 702, the process 700 can cause the one or more processors to initialize a virtual machine to execute a set of operations associated with a transaction of a blockchain. At block 703, the process 700 can cause the one or more processors to receive a block of the blockchain via the peer-to-peer connection, the block including data to specify the transaction, wherein the transaction is cryptographically associated with an electronic record, the electronic record is cryptographically associated with multiple actors, and the multiple actors includes a non-central authoritative actor associated with at least one of the one or more additional computing systems.

In one embodiment, the process 700 can cause the one or more processors to load a consensus rule associated with the transaction, as shown at block 704. The consensus rule can define a set of cryptographic operations to validate the transaction and authenticate one or more actors associated with the transaction. The operational logic of the consensus rule can be defined by the authoritative actor, such as a jurisdictional government that participates in the transference tracking system.

The process 700 can then cause the one or more processors to execute instructions derived from the consensus rule to authenticate the one or more actor identifiers associated with the transaction, validate the authenticity of the transaction, and validate the electronic record associated with the transaction, as shown at block 705. The process 700 can then cause the one or more processors to register a vote associated with the validity of the electronic record associated with the transaction, the vote registered with the one or more additional computing systems via the peer-to-peer connection, as shown at block 706.

In one embodiment, the vote registered via the peer-to-peer connection can be used to determine a consensus as to the validity of an electronic record. All nodes within the invoice blockchain can replicate the transaction to arrive at a mutual consensus as to the validity of the electronic record. For example, the transaction can be associated with a smart contract, where the output of the smart contract constitutes validation and authorization from an authoritative entity. An authentication number or a protocol number associated with the electronic record can be recorded and used as a base for a hash block to be added to the invoice blockchain. In many instances, the non-central authoritative actor would be a jurisdictional government, such as a local, state, or national government that is tasked with overseeing commercial transactions and tax collections associated with such transactions. Various stakeholders in the transaction associated with the electronic record can use APIs provided by the invoice blockchain system to query certain details or status elements of the electronic record during the distribution of goods or services specified by the electronic record.

In one embodiment, the non-central authoritative entity described herein is a non-central authority that manages a geographical localized financial infrastructure. In one embodiment, the transaction participant entities include a transaction participant receiving entity and the transaction detail data excludes identification information of the transaction participant receiving entity to enable pseudonymity for the receiving identity. In one embodiment, authenticating the one or more actor identifiers associated with the transaction includes generating an authentication identifier or recording a generated authentication identifier associated with the authentication of the one or more entity identifiers. The authentication identifier associated with an electronic record can be used to generate a hash value to identify a block to be added to the transaction. Additionally, or alternatively, a protocol identifier for a protocol used for the transaction can be used to generate a hash value to identify a block to be added to the blockchain. In one embodiment, the operations can additionally include receiving a request, via the network interface, to authenticate an entity identifier associated with a transaction record within the blockchain. Compute nodes associated with participants in the transference tracking system can perform various blockchain transactions, including transactions that are outsourced from other nodes. For example, a compute node on the transference tracking system may receive a request to authenticate or validate a transaction on the blockchain that may be unrelated to transactions of that actor, although transactions for a certain set of actors can be limited to nodes within that set of actors.

In one embodiment, the instructions derived from the consensus rule are associated with a smart contract executed at the blockchain. In one embodiment, validating the authenticity of the transaction record includes performing a Merkle proof on a branch of the Merkle Tree referencing the transaction record.

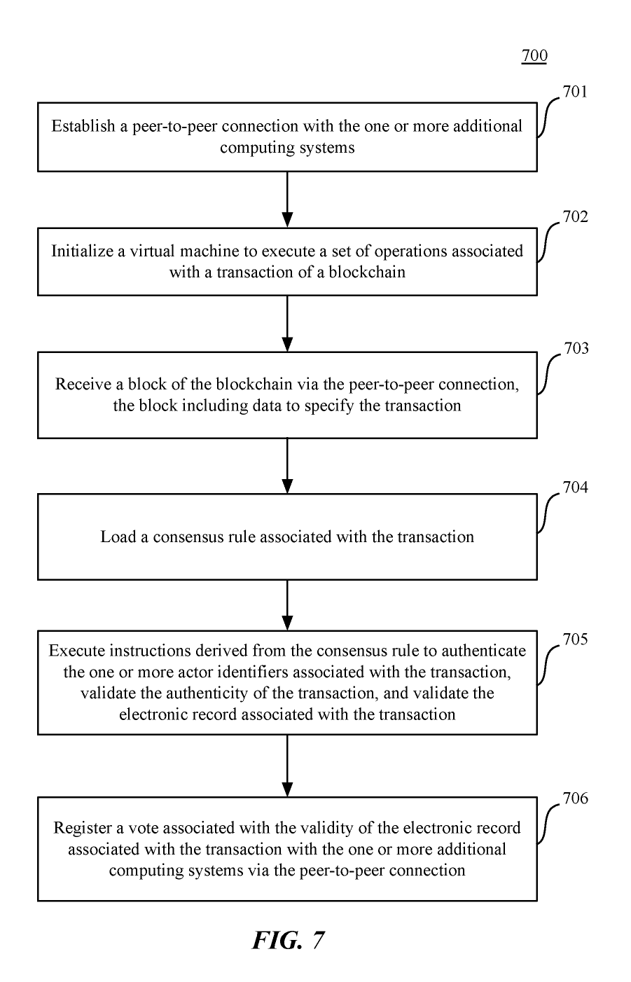

FIG. 8 illustrates an electronic transference tracking system 800, according to embodiments described herein. The various actors within the electronic transference tracking system 800 can use the blockchain of the system to enable secure execution of transactions for goods and services in a manner that is compliant with the laws and regulations associated with various jurisdictions. The various actors within the electronic transference tracking system 800 can include, but are not limited to a supplier actor 802, a logistics actor 804, and a buyer actor 806, where the supplier actor 802 provides goods to be sold within a jurisdiction, a logistics actor 804 provides storage, shipping, and/or delivery services within the jurisdiction, and the buyer actor 806 is a wholesale, retail, or end-user buyer within the jurisdiction. The actors can act in concert with an authorizing entity 808. The authorizing entity 808, and each actor (e.g., supplier actor 802, logistics actor 804, buyer actor 806) can have an associated transference tracking system identifier (TTS ID 823, TTS ID 825, TTS ID 827, TTS ID 829) that is used to identify the actor within the electronic transference tracking system 800. Each transaction performed by an actor can be associated with the actor identifier, such that an identifier for the actor is recorded in the TTS blockchain, even if the actor associated with the identifier is anonymous. In one embodiment, the TTS identifiers can be unique identifiers that can be generated for an actor when the actor joins the electronic transference tracking system 800. In one embodiment, the TTS identifiers can be hardware identifiers associated with computational hardware used to perform transactions at each TTS node.

In one embodiment, each actor within the transference tracking system is associated with an TTS node, the supplier actor 802 having TTS node 822, the logistics actor 804 having TTS node 824, the buyer actor 806 having TTS node 826, and the authorizing entity 808 having TTS node 828. In one embodiment, each TTS node is computational system interconnected over a network in a peer-to-peer hierarchy, including TTS node 828 of the authorizing entity 808. The TTS nodes includes transference tracking system data and metadata, as well as software logic to enable protocols and/or APIs to enable other computing systems to compute with the TTS nodes. The TTS nodes can each include blockchain data used by the transference tracking system. The authorizing entity 808 is non-central to the TTS blockchain. The TTS blockchain data is distributed and replicated across the various TTS nodes, rather than having the authorizing entity 808 act as a centralized database.

The various TTS nodes of the goods and/or service providers (e.g., supplier actor 802, logistics actor 804, buyer actor 806) in one embodiment, can exchange electronic record and/or transaction data with respective ERP systems 812, 814, 816, or equivalent resource management and/or planning systems associated with each actor. The specifics of the various ERP systems can vary, and TTS nodes can also send and receive electronic record information to and from other sources. In one embodiment, the authorizing entity 808 can also act in concert with a tax system 818 or another computing system associated with a tax or regulatory agency associated with the authorizing entity, particularly when the authorizing entity is a jurisdictional government. In one embodiment, the tax system 818 can include or be associated with the tax engine 120 of FIG. 1.

The illustrated electronic transference tracking system 800 can be configured to implement electronic invoicing within a given jurisdiction. Furthermore, multiple transference tracking systems can be connected to enable multi-jurisdictional operation. For example, multiple authorizing entities associated with different actors can enable multi-jurisdictional transactions using smart contracts, where the consensus rules for the smart contracts can vary based on the jurisdiction.

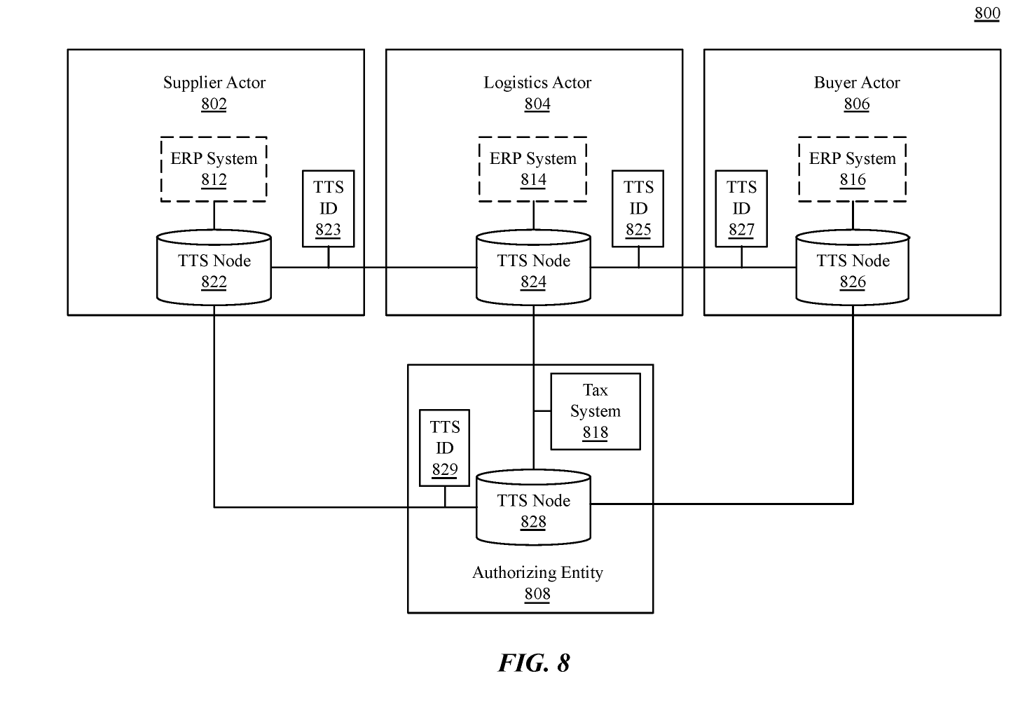

FIG. 9 illustrates a computing system architecture 900 for transaction validation, according to an embodiment. In one embodiment, an ERP system 910 associated with actor can create and populate transaction records that can be validated via the transference tracking system. The ERP system 910 can communicate with a transaction actor TTS node 920, which is the TTS node associated with the actor that initiates the transaction. In one embodiment, the ERP system 910 can create an ERP transaction record at block 912. The ERP transaction record can be created within the ERP system 910 before a corresponding record is created on the blockchain of the TTS system. The actual creation of the transaction record on the TTS blockchain can be performed by the transaction actor TTS node 920.

The ERP system 910 can populate record details for the transaction at block 914. The record details can include various elements of information that specifies details of a transaction, such as the actors or participants in the transaction, the type of transaction (e.g., goods, services, etc.), a value associated with the transaction, and tax data associated with the transaction, such as taxes paid for the transaction. Some or all of the transaction record details can be transmitted to the transaction actor TTS node 920 via a TTS API (e.g., TTS API 214 as in FIG. 2).

The transaction actor TTS node 920 can receive the transaction record details at block 922. In one embodiment, an un-validated transaction record can be created by the transaction actor TTS node 920 to store the record details. In other embodiments, a provisional transaction record can be created to store data for use in validating and authenticating the transaction record details. The transaction actor TTS node 920 can distribute record detail to other TTS nodes at block 924.

In one embodiment, un-validated or provisional transaction records can be validated via one or more validation actor TTS node(s) 930. The one or more validation actor TTS node(s) 930 can validate the record according to consensus rules defined by an authority at block 932. The consensus rules can require, for example, that the details associated with a transaction record be well-formed and complete, that the actor identifiers and signatures are valid, and that the appropriate tax and regulatory requirements have been met for the transaction. The specific validation requirements can vary for different authorities or jurisdictions.

In various embodiments and implementations, validation of transaction records can be performed according to one of multiple policies. In one embodiment, an authoritative entity within a jurisdiction can validate all transactions. In such embodiment, the authorizing entity (e.g., authorizing entity 808 as in FIG. 8) can host a TTS node (e.g., TTS node 828 as in FIG. 8) that is designated as the validation actor TTS node for all transactions. The authorizing entity can validate the transaction record details according to a pre-determined validation process. Alternatively, the authoritative entity can define consensus rules that are used to validate a transaction record. Those consensus rules can be used to derive program logic that can be executed by actor TTS nodes. All actors in the transference transaction system will agree to the consensus rules and consensus logic. In one embodiment, any actor, via the TTS node of the actor, can act as one of the validation actor TTS node(s) 930. Where any actor node can act as the one or more validation actor TTS node(s) 930, multiple nodes may execute the program logic to validate transaction record details. For example, a first one of the validation actor TTS node(s) 930 can validate the record according to consensus rules from the authority at block 932, while a second one of the validation actor TTS node(s) 930 can validate the record according to consensus rules from the authority at block 933.

In one embodiment, the first or second one of the validation actor TTS node(s) 930, or a third, different one of the validation actor TTS node(s) 930, can act as a correlator. The correlator can correlate consensus data and authenticate identities of the one or more validation actor TTS node(s) 930 at block 934. Correlating consensus data includes reviewing the validation votes placed by each of the validation actor TTS node(s) 930 to determine if the transaction record details will be designated as valid. The outcome can vary based on the consensus policy in place. In one embodiment, a majority of validating actors may be required to indicate that the transaction record data is valid. In one embodiment, all validating actors may be required to indicate that the transaction record data is valid. Based on the consensus policy, the correlator can determine whether the transaction record data has been validated.

In one embodiment, the correlator, at block 934, can also authenticate the identities of the validation actor TTS node(s) 930 to determine that valid actors and valid nodes have been used for the record data validation. Authenticating the identities can include determining the validity of signatures, keys, or certificates used to identify the validation actor TTS node(s) 930.

The validation result can be communicated via the TTS blockchain to the transaction actor TTS node 920. The transaction actor TTS node 920 can request a commit operation to be performed for the authorization data at block 926. The commit operation can be performed by the transaction actor TTS node 920 or can be performed by a different TTS node. In one embodiment, a single node can be designated for commit operations, where the designated commit node can be an actor node or a non-actor node associated with the implementation infrastructure of the transference tracking system. In various embodiments the commitment of authorization can include writing a transaction record to the blockchain along with authorization data or append authorization data to an un-validated transaction record. The commitment result can be written to the blockchain whether or not the transaction record data has been determined to be valid, with either a valid or invalid result committed to the blockchain.

The ERP system 910, at block 915, can receive an indication of whether the transaction record has been authorized. If the transaction record is not authorized, error data can be examined to determine why the transaction record data was not validated. The ERP system 910 can then resolve the error at block 917 and restart the process, returning to block 912. If at block 915 the record is determined to be authorized, the ERP system 910 can trigger transference operations at block 916. The transference operations can include a set of manual or automated operations that are to provide the goods or services associated with the transaction record. For example, software logic within the ERP system 910 can be triggered that indicates that a transfer or transaction in good or services is to be performed or has been performed.

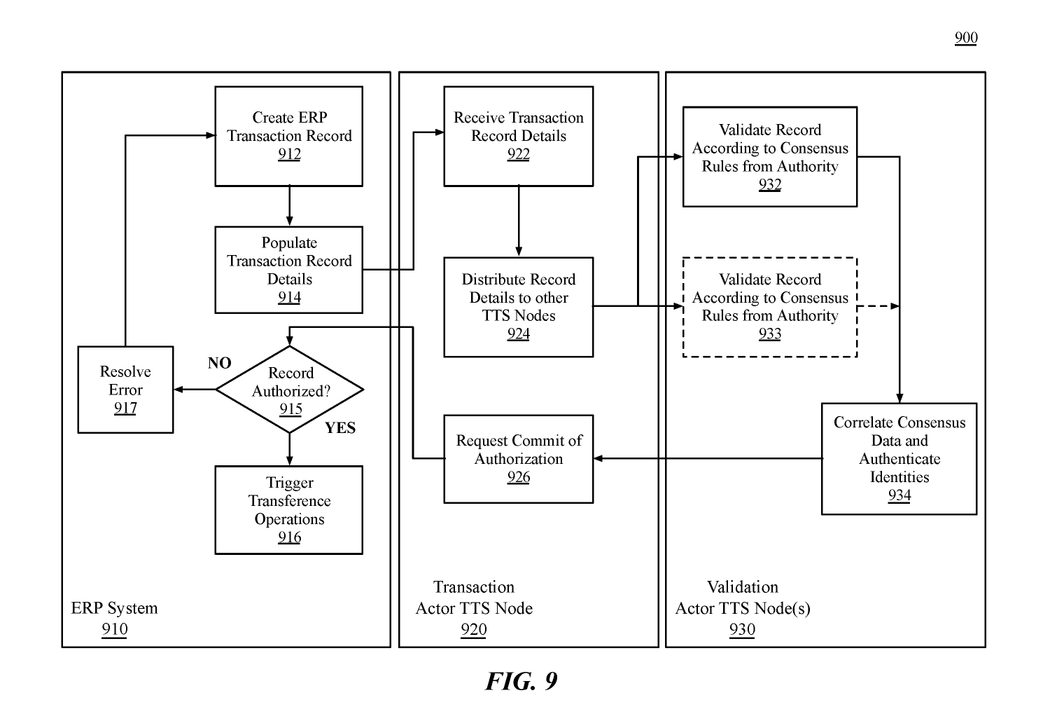

FIG. 10 illustrates a transaction record 1000, according to an embodiment. The transferences transaction record 1000 can include record detail data 1010 and authorization status 1020. The record detail data 1010 includes details of a transference transaction associated with the transaction record. In one embodiment, the record detail data 1010 includes an actor identifier 1011, a transaction identifier 1014, and a transaction value data structure 1012. The authorization status 1020 includes details that indicate whether the transaction record 1000 has been validated and authorized, has yet to be validated, or has been determined to be invalid. In one embodiment, the authorization status 1020 includes an authorization identifier 1022, authorizing actor identifier(s) 1024, and a visibility policy 1026.

Within the record detail data 1010, the actor identifier 1011 is an identifier for the actor that originates the transference transaction associated with the transaction record. The actor identifier 1011 can be recorded in the TTS blockchain, even if more specific identifying information for the actor is not recorded in the TTS blockchain. The actor identifier 1011 can also be referred to as an entity identifier. In one embodiment the actor identifier 1011 can be a unique or quasi-unique identifier that is generated for an actor when the actor joins the electronic transference tracking system. In one embodiment, the actor identifier 1011 can be generated based on one or more hardware identifiers associated with computational hardware used to perform transactions at each TTS node. The transaction identifier 1014 is a unique or quasi-unique identifier for the transaction for which the transaction record is associated and can be used to reference the transference transaction within the transference transaction system. In one embodiment the transaction identifier 1014 can also have relevance outside of the system. For example, the transaction identifier 1014 can be imported or derived from transaction data within an ERP system. Imported identifiers can be deterministically modified to avoid when importing identifiers from multiple different ERP systems.

In one embodiment, the transaction value data structure 1012 can be a general-purpose data structure that can store a variety of information related to the transaction. Data in the transaction value data structure 1012 can be divided into on-chain data 1016 and off-chain references 1018. The on-chain data 1016 can includes the set of data that is stored within a record on the TTS blockchain. The on-chain data 1016 can include actor identifiers for each actor that is involved with the transference transaction that is tracked via the transaction record 1000. The on-chain data can also include a transaction type identifier that indicates the type of transaction being performed. The transaction type identifier can be standardized within the transference tracking system, such that an identifier is associated with each type of transaction to be tracked. Exemplary transaction types include but are not limited to wholesale transactions, storage transactions, freight transactions, retail transactions, and other types of transference transactions that can be tracked by the transference tracking system. In one embodiment, the transaction record 1000 can also be used to track auditing and taxation operations that may be performed by a jurisdictional authority. Validated and/or authenticated records of auditing actions can also be stored to the TTS blockchain.

The off-chain references 1018 can include references or locators to data or services that are relevant to a transaction but are stored off of the TTS blockchain. Off-chain references 1018 can reference APIs and/or web services provided by actors or authorities that enable access to information that may be relevant to the transaction but for policy or design reasons are not stored on the TTS blockchain. For example, an off-chain reference to personal consumer information (PCI) can be stored within the off-chain references 1018, enabling PCI information to be retrieved by entities with valid reasons to access such data, without requiring the PCI to be stored on the blockchain. In one embodiment, additional personal identifying information (PII) for an actor can be stored. In such embodiment, the actor identifier 1011 can uniquely identify an actor without requiring more specific identifying information for an actor to be stored on-chain. Entities that are authorized to reference the PII for an actor can do so via an off-chain reference. In some embodiments, information required to validate the transaction record 1000 is stored only within on-chain data 1016. However, in some embodiments one or more of the off-chain references 1018 can be used during validation of the transaction record 1000 if all actors that may perform record validation have access to the one or more references, at least for the duration of the validation operations.

Within the authorization status 1020, the authorization identifier 1022 includes an indicator that the data of the transaction record 1000 has been validated, has not yet been validated, or has been determined to be invalid. In one embodiment, where the data of the transaction record 1000 has been validated, a digital certificate 1023 can be included with, linked, or otherwise associated with the authorization identifier 1022. The authorizing actor identifier(s) 1024 can include identifiers of an actor that performed a validation or authorization action on the transaction record 1000. In one embodiment, the authorizing actor identifier(s) 1024 can identify an actor that committed or requested commitment of the authorization for the transaction record 1000. In one embodiment, the authorizing actor identifier(s) 1024 can also include an identifier for an actor that correlated validation operations performed by other actors.

The visibility policy 1026 can indicate the fields of the transaction record 1000 that are visible to actors within the transference transaction system. The visibility policy 1026 can specify a list of blocked actors that cannot view one or more specific fields within the record detail data 1010. In one embodiment the visibility policy 1026 can specify a list of actors that are permitted to view one or more specific fields within the record detail data 1010. The visibility policy 1026 can also specify a default visibility for fields of the record detail data 1010. In one embodiment, visibility policy 1026 can specify that some fields of the record detail data 1010 are only visible to a subset of actors. For example, some fields may be visible only to a set of specified actors that have a vendor or supply chain relationship, without allowing unrelated actors to view those fields. In one embodiment, some fields may be visible only to actors that are configured to validate the record detail data 1010. For example, if a single actor, such as a jurisdictional authority, is authorized to validate record detail data 1010, the visibility policy 1026 may result in some of fields of the record detail data being visible only to the single validation actor and the actor that created the transaction record 1000. In one embodiment the visibility policy 1026 can apply to a subset of the illustrated fields of the record detail data 1010. For example, the visibility policy 1026 can specify visibility of one or more references in the off-chain references 1018, or one or more elements of the on-chain data 1016.

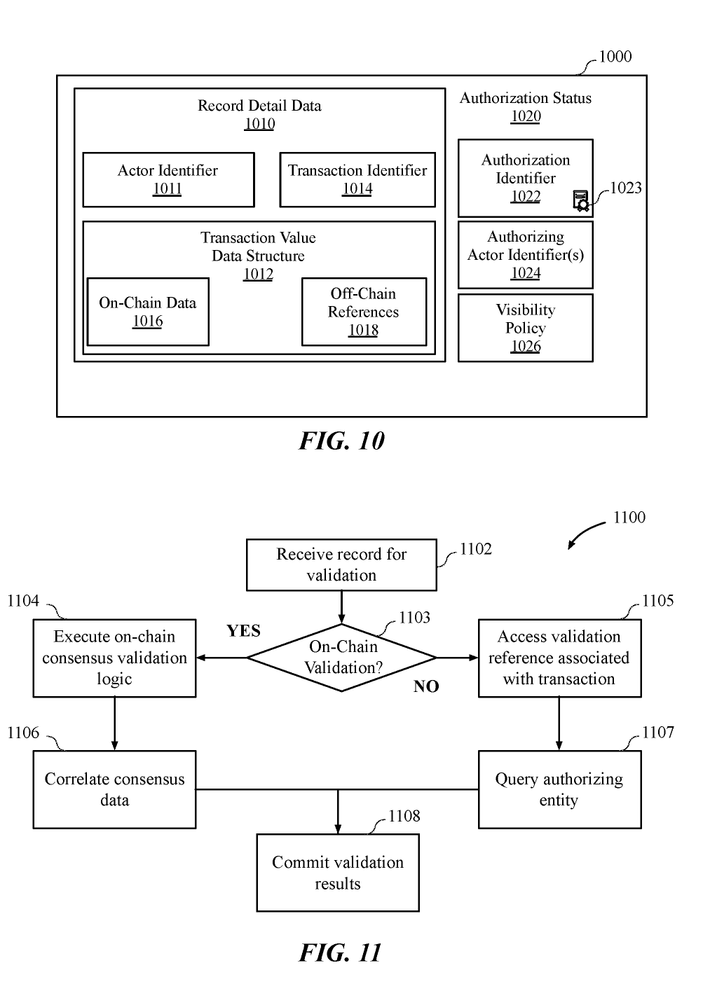

FIG. 11 illustrates a process 1100 to validate transaction record details, according to an embodiment. The process 1100 can be performed by a TTS node associated with an actor, which is referred to herein as the validating actor or the validating actor node. A single validating actor can validate a transaction record or transaction record data or multiple validating actors can validate the record. As shown at block 1102, a validating actor can receive a record or record data for validation. In some embodiments, validating a transaction can include performing on-chain validation of on-chain data or off-chain validation using off-chain references. If, at block 1103, the validating actor determines that on-chain validation is to be performed, the validation actor can execute on-chain consensus validation logic at block 1104. The details of the on-chain consensus validation logic can vary based on the consensus rules specified by the jurisdictional authority. One or more validating actors can execute the on-chain consensus validation logic. Depending on the system configuration, the validating actor can then correlate the consensus data 1106 at block, or a different validation actor can correlate the consensus data. Correlating the consensus data can perform operations described with respect to block 934 of FIG. 9.

If, at block 1103, the validation actor determines that off-chain validation is to be performed, the validation actor can access a validation reference associated with the transaction at block 1105. The validation reference can be an off-chain reference to an API of web service of an authorizing entity and/or a protocol number by which the off-chain validation can be retrieved. The validation actor can then query the authorizing entity at block 1107 to retrieve the off-chain validation results for the transaction record. Off-chain validation can be performed when the authorizing entity (e.g., authorizing entity 280 as in FIG. 2) has an actor node on the TTS blockchain and stores validation records or perform validation of transaction data using a separate system. In this manner, hybrid functionality can be enabled in which the TTS system is used for some aspect of transference tracking while other systems are used for other aspects of transference tracking.

In one embodiment, off-chain validation can be performed via an off-chain reference to a separate system managed by the authorizing entity. In such embodiment, the authorizing entity can present a network API or web service by which the transference tracking system can query the existence of a valid transaction within a different system. In a further embodiment, the authorizing entity may not be required to have an actor node on the TTS blockchain. Instead, the validation actor can query the authority to determine a validation status.

For off-chain and on-chain validation the validation actor can commit the validation results at block 1108. The validation actor can commit the validation results or request that the validation results be committed. Committing the validation results can include appending data to the TTS blockchain that indicates that a transaction record is valid or invalid. In one embodiment the validation actor can request that the validation result be committed as described with respect to block 926 of FIG. 9.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense. The specifics in the descriptions and examples provided may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein. Additionally, various components described herein can be a means for performing the operations or functions described in accordance with an embodiment.

One embodiment provides for a computing system comprising an interconnect to couple hardware components within the computing system; a network interface coupled with the interconnect, the network interface to enable a peer-to-peer connection with one or more additional computing systems; a non-transitory machine-readable medium coupled with the interconnect, the non-transitory machine readable medium storing instructions; one or more processors coupled with the interconnect, the one or more processors to execute instructions stored on the non-transitory machine-readable medium, the instructions to cause the one or more processors to establish the peer-to-peer connection with the one or more additional computing systems.

In one embodiment, the one or more processors of the computing system can initialize a virtual machine to execute a set of operations associated with an electronic record of a transaction, the transaction corresponding to a transference of one of physical items and services between transaction participant entities. The operations can additionally include to receive a block of the blockchain via the peer-to-peer connection, where the block includes transaction detail data to be stored within a transaction record. The transaction record can be cryptographically associated with multiple entity identifiers, the multiple entity identifiers including an entity identifier of a non-central authoritative entity associated with at least one of the one or more additional computing systems.

The one or more processors can be additionally configured to load a consensus rule associated with the transaction record, the consensus rule to define a set of cryptographic operations to validate the transaction record and authenticate one or more entity identifiers associated with the transaction record. The consensus rule can include operational logic defined by the non-central authoritative entity. The one or more processors can then execute instructions derived from the consensus rule to perform operations including authenticating the one or more entity identifiers associated with the transaction record, validating the authenticity of the transaction detail data, and recording an indication of a validation status at the blockchain.

Other features of the present embodiments will be apparent from the accompanying drawings and from the detailed description above. Accordingly, the true scope of the invention will become apparent to the skilled practitioner upon a study of the drawings, specification, and following claims.

What is claimed is:

1. A computing system comprising:
an interconnect to couple hardware components within the computing system;
a network interface coupled with the interconnect, the network interface to enable a peer-to-peer connection with one or more additional computing systems;
a non-transitory machine-readable medium coupled with the interconnect, the non-transitory machine-readable medium storing first instructions;
one or more processors coupled with the interconnect, the one or more processors to execute the first instructions stored on the non-transitory machine-readable medium, the first instructions to cause the one or more processors to:
establish the peer-to-peer connection with the one or more additional computing systems;
validate an electronic record of a transaction, the transaction corresponding to a transference of one of physical items and services between transaction participant entities; and
store an authenticated record of the transaction to a shared database, the shared database distributed via the peer-to-peer connection with the one or more additional computing systems.

2. The computing system as in claim 1, the shared database stored on a blockchain, the blockchain to be shared with the one or more additional computing systems, wherein the blockchain is a permissioned blockchain.

3. The computing system as in claim 2, wherein to validate the electronic record of the transaction includes to:
initialize a virtual machine to execute a set of operations associated with the electronic record of the transaction; and
execute second instructions within the virtual machine to validate the transaction, the second instructions derived from a consensus rule associated with the electronic record of the transaction.

4. The computing system as in claim 3, the second instructions to perform operations to:
authenticate one or more entity identifiers associated with the electronic record of the transaction;
validate transaction detail data; and
record an indication of a validation status to the blockchain.

5. The computing system as in claim 3, first instructions additionally to cause the one or more processors to:
receive a block of the blockchain via the peer-to-peer connection, the block including transaction detail data to be stored within the electronic record of the transaction, wherein the electronic record of the transaction is cryptographically associated with multiple entity identifiers, the multiple entity identifiers including an entity identifier of a non-central authoritative entity associated with at least one of the one or more additional computing systems; and
load the consensus rule associated with the electronic record of the transaction, the consensus rule to define a set of cryptographic operations to validate the electronic record of the transaction and authenticate one or more entity identifiers associated with the electronic record of the transaction, wherein the consensus rule includes operational logic defined by the non-central authoritative entity.

6. The computing system as in claim 5, wherein the non-central authoritative entity is a non-central authority that manages a geographical localized financial infrastructure.

7. The computing system as in claim 5, wherein the transaction participant entities include a transaction participant receiving entity and the transaction detail data excludes identification information of the transaction participant receiving entity.

8. The computing system as in claim 5, wherein the transaction detail data includes one or more of an actor identifier associated with the transaction, a type of transaction, and taxation data associated with the transaction.

9. The computing system as in claim 5, wherein to authenticate the one or more entity identifiers associated with the electronic record of the transaction includes to generate or record an authentication identifier associated with the authentication of each of the one or more entity identifiers.

10. The computing system as in claim 9, the one or more processors additionally to use the authentication identifier to generate a hash value to identify a block to be added to the blockchain.

11. The computing system as in claim 9, the one or more processors additionally to use a protocol identifier to generate a hash value to identify a block to be added to the blockchain.

12. A non-transitory machine-readable medium storing first instructions which, when executed by one or more processors of a computing system, cause the computing system to perform operations including:
establishing a peer-to-peer connection with one or more additional computing systems;
initializing a virtual machine to execute a set of operations associated with an electronic record of a transaction, the transaction corresponding to a transference of one of physical items and services between transaction participant entities;
receiving a block of a blockchain via the peer-to-peer connection, the block including transaction detail data to be stored within a transaction record, wherein the transaction record is cryptographically associated with multiple entity identifiers, the multiple entity identifiers including an entity identifier of a non-central authoritative entity associated with at least one of the one or more additional computing systems, and the blockchain is a permissioned blockchain storing a database that is distributed to and shared with the one or more additional computing systems;
loading a consensus rule associated with the transaction record, the consensus rule to define a set of cryptographic operations to validate the transaction record and authenticate one or more entity identifiers associated with the transaction record, wherein the consensus rule includes operational logic defined by the non-central authoritative entity; and
executing second instructions derived from the consensus rule to perform operations to validate the electronic record of the transaction.

13. The non-transitory machine-readable medium as in claim 12, the operations additionally including receiving a request, via the peer-to-peer connection, to authenticate an entity identifier associated with a transaction record within the blockchain.

14. The non-transitory machine-readable medium as in claim 13, wherein the entity identifier associated with a transaction record is derived from a hardware identifier.

15. The non-transitory machine-readable medium as in claim 12, the operations additionally including receiving a request, via the peer-to-peer connection, to validate authenticity of the transaction record within the blockchain.

16. The non-transitory machine-readable medium as in claim 12, wherein the second instructions derived from the consensus rule are associated with a smart contract executed at the blockchain, wherein the block of the blockchain includes a hash value to identify a previous block of the blockchain and the block additionally includes a root of a hash tree.

17. The non-transitory machine-readable medium as in claim 16, wherein the hash tree is a Merkle Tree and validating authenticity of the transaction record includes performing a Merkle proof on a branch of the Merkle Tree referencing the transaction record.

18. A method performed on a computing system, the method comprising:
establishing a peer-to-peer connection with one or more additional computing systems;
initializing a virtual machine to execute a set of operations associated with an electronic record of a transaction, the transaction corresponding to a transference of one of physical items and services between transaction participant entities;
receiving a block of a blockchain via the peer-to-peer connection, the block including transaction detail data to be stored within a transaction record, wherein the transaction record is cryptographically associated with multiple entity identifiers, the multiple entity identifiers including an entity identifier of a non-central authoritative entity associated with at least one of the one or more additional computing systems, and the blockchain is a permissioned blockchain storing a database that is distributed to and shared with the one or more additional computing systems;
loading a consensus rule associated with the transaction record, the consensus rule to define a set of cryptographic operations to validate the transaction record and authenticate one or more entity identifiers associated with the transaction record, wherein the consensus rule includes operational logic defined by the non-central authoritative entity; and
executing second instructions derived from the consensus rule to perform operations to validate the electronic record of the transaction, wherein to validate the electronic record of the transaction includes to authenticate the one or more entity identifiers associated with the transaction record, validate authenticity of the transaction detail data, and record an indication of a validation status to the blockchain.

19. The method as in claim 18, wherein the second instructions derived from the consensus rule are associated with a smart contract executed at the blockchain, wherein the block of the blockchain includes a hash value to identify a previous block of the blockchain and the block additionally includes a root of a hash tree.

20. The method as in claim 19, wherein the hash tree is a Merkle Tree and validating the authenticity of the transaction record includes performing a Merkle proof on a branch of the Merkle Tree referencing the transaction record.
